(19) United States
(12) Patent Application Publication
(10) Pub. No.: US 2025/0299653 A1
(43) Pub. Date: Sep. 25, 2025

(54) INFORMATION PROCESSING APPARATUS, ELECTRONIC MUSICAL INSTRUMENT, AND METHOD

(71) Applicant: CASIO COMPUTER CO., LTD., Tokyo (JP)

(72) Inventor: Rie MAEDA, Tokyo (JP)

(73) Assignee: CASIO COMPUTER CO., LTD., Tokyo (JP)

(21) Appl. No.: 19/084,280

(22) Filed: Mar. 19, 2025

(30) Foreign Application Priority Data
Mar. 19, 2024 (JP) 2024-043593

(51) Int. Cl. G10H 1/00

(52) U.S. Cl. CPC G10H 1/0008; G10H 1/0066; G10H 2210/066; G10H 2210/576; G10H 2240/161; G10H 2240/311

(57) ABSTRACT

An information processing apparatus includes: a memory; and at least one processor. The at least one processor is configured to, as music progresses in accordance with music data, sequentially write or overwrite each of a plurality pieces of chord data included in the music data to the memory, the chord data being a performing data played by a user, detect a user operation on manipulation elements by a user, and process to sound one or more chord component notes corresponding to the piece of chord data stored in the memory at a timing of detecting the user operation, the one or more chord component notes being in number according to the number of user operations of the manipulation elements, to which the user operations are being detected.

### CROSS-REFERENCE TO RELATED APPLICATIONS

This application claims priority to Japanese Patent Application No. 2024-043593, filed Mar. 19, 2024, the entire specification, claims, abstract and drawings of which are incorporated by reference.

### BACKGROUND OF THE INVENTION

### 1. Field of the Invention

The disclosure herein relates to information processing apparatuses, electronic musical instruments, and methods.

### 2. Related Art

An apparatus for assisting the user's operation to play an electronic musical instrument is known (see, for example, Japanese Unexamined Patent Application Publication No. 2002-40921).

This apparatus instructs the user which keys to press according to the chord progression data of a song. The user is allowed to play a chord by following this instruction and pressing the keys that make up the chord.

However, musical tones that are not musically appropriate may be produced when the user plays with some manipulation elements for musical performance.

### SUMMARY OF THE INVENTION

An information processing apparatus according to one embodiment of the present disclosure includes: a memory; and at least one processor.

The at least one processor is configured to, as music progresses in accordance with music data, sequentially write or overwrite each of a plurality pieces of chord data included in the music data to the memory, the chord data being a performing data played by a user, detect a user operation on manipulation elements by a user, and process to sound one or more chord component notes corresponding to the piece of chord data stored in the memory at a timing of detecting the user operation, the one or more chord component notes being in number according to the number of user operations of the manipulation elements, to which the user operations are being detected.

### BRIEF DESCRIPTION OF THE DRAWINGS

FIG. 1 is a block diagram showing the configuration of a musical instrument system in accordance with one embodiment of the present disclosure.

FIG. 2 describes an overview of the information processing apparatus, method, and program according to one embodiment of the present disclosure.

FIG. 3 describes an overview of the information processing apparatus, method, and program according to one embodiment of the present disclosure.

FIG. 4 describes how to determine the chord component notes to be sounded among the candidate notes to be sounded in one embodiment of the present disclosure.

FIG. 5 describes how to determine the chord component notes to be sounded among the candidate notes to be sounded in one embodiment of the present disclosure.

FIG. 6 describes how to determine the chord component notes to be sounded among the candidate notes to be sounded in one embodiment of the present disclosure.

FIG. 7 describes how to determine the chord component notes to be sounded among the candidate notes to be sounded in one embodiment of the present disclosure.

FIG. 8 describes how to determine the chord component notes to be sounded among the candidate notes to be sounded in one embodiment of the present disclosure.

FIG. 9 is a flowchart of the process performed by a processor in an information processing apparatus in one embodiment of the present disclosure.

FIG. 10 describes a subroutine for the music progression process in step S104 in FIG. 9.

FIG. 11A describes a subroutine for the performance operation process in step S105 in FIG. 9.

FIG. 11B describes a subroutine for the performance operation process in step S105 in FIG. 9.

FIG. 12 describes how to select chord component notes in another embodiment of the present disclosure.

### DESCRIPTION OF THE PREFERRED EMBODIMENTS

One embodiment of the present disclosure provides an information processing apparatus, an electronic musical instrument, and a method, which are capable of producing musically appropriate tones that correspond to the user's performance expression, regardless of what operation the user performs.

The following description relates to an information processing apparatus, an electronic musical instrument, and a method according to one embodiment of the present disclosure. Like numbers indicate like components throughout the drawings, and their duplicated descriptions are simplified or omitted as appropriate.

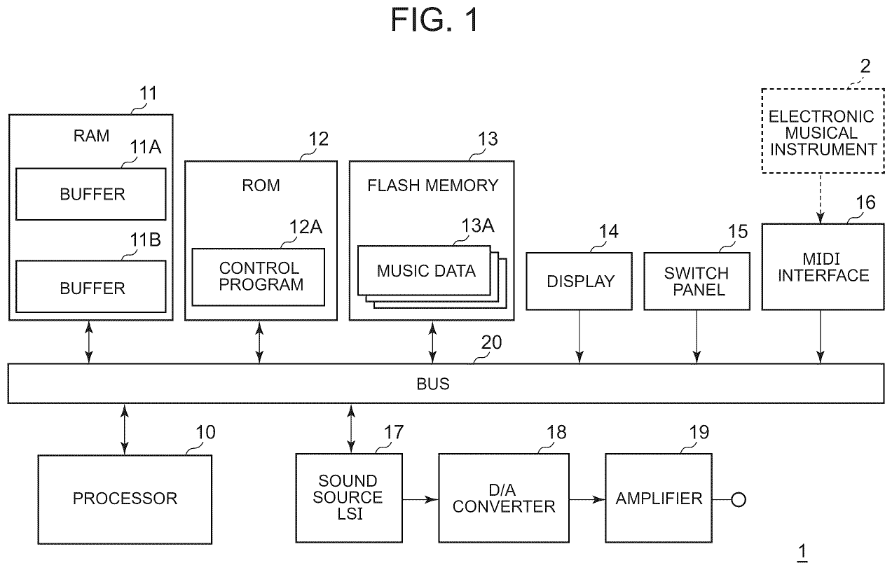

As shown in FIG. 1, a musical instrument system according to one embodiment of the present disclosure includes an information processing apparatus 1 and an electronic musical instrument 2. The information processing apparatus 1 and the electronic musical instrument 2 are connected to be communicable with each other via wire or wirelessly.

The information processing apparatus 1 is dedicated to electronic musical instruments equipped with a sound source. The information processing apparatus 1 may be replaced by other apparatuses such as a smartphone, a tablet terminal, a personal computer (PC), and a game controller. For instance, a smartphone or a tablet terminal is operable as the information processing apparatus 1 by downloading an application for executing various processes according to one embodiment of the present disclosure from an app store and installing it. In this case, the user is allowed to operate the information processing apparatus 1 by performing a touch operation on a graphical user interface (GUI) screen, on which various components are laid out.

The electronic musical instrument 2 is an example of an apparatus for musical performance. For instance, the electronic musical instrument 2 is an electronic keyboard. The electronic musical instrument 2 may be an electronic keyboard instrument such as an electronic piano, other than an electronic keyboard. The electronic musical instrument 2 may be another form of electronic musical instrument, such as an electronic percussion instrument, an electronic wind instrument, or an electronic string instrument.

The keyboard of the electronic musical instrument 2 is equipped with 88 keys, which are an example of manipulation elements for musical performance (hereinafter simply called manipulation elements). That is, the electronic musical instrument 2 is an example of a musical-performance apparatus equipped with a plurality of manipulation elements. The manipulation elements are also called keys. Each key is associated with a different pitch from A0 to C8.

In this disclosure, the international notation will be used for description, with pitch C4 being note number 60. Therefore, the note numbers corresponding to the pitches A0 to C8 are 21 to 108. A pitch may be called a note. Note numbers may be called key numbers or musical instrument digital interface (MIDI) keys. The number of keys on a keyboard is not limited to 88. The number of keys may be 61 or 76, for example.

Pitch names represent the absolute pitch, and are specifically written as C, C#, D, D #, E, F, F #, G, G #, A, A #, and B. These pitch names C to B may be expressed as pitch name numbers 0 to 11, respectively.

The electronic musical instrument 2 outputs MIDI data to the information processing apparatus 1 in response to a performance operation by a user. Hereinafter, this MIDI data will be referred to as “MIDI data D”. The MIDI data D output from the electronic musical instrument 2 includes various messages such as note-on, note-off, and control change.

In another embodiment, a musical instrument app that reproduces the electronic musical instrument 2 may be installed in the information processing apparatus 1. In this case, the user is allowed to perform music-performance operations on the musical instrument app instead of with the electronic musical instrument 2. In yet another embodiment, the information processing apparatus 1 may be built into the electronic musical instrument 2. In this case, the information processing apparatus 1 may be an element of the electronic musical instrument 2.

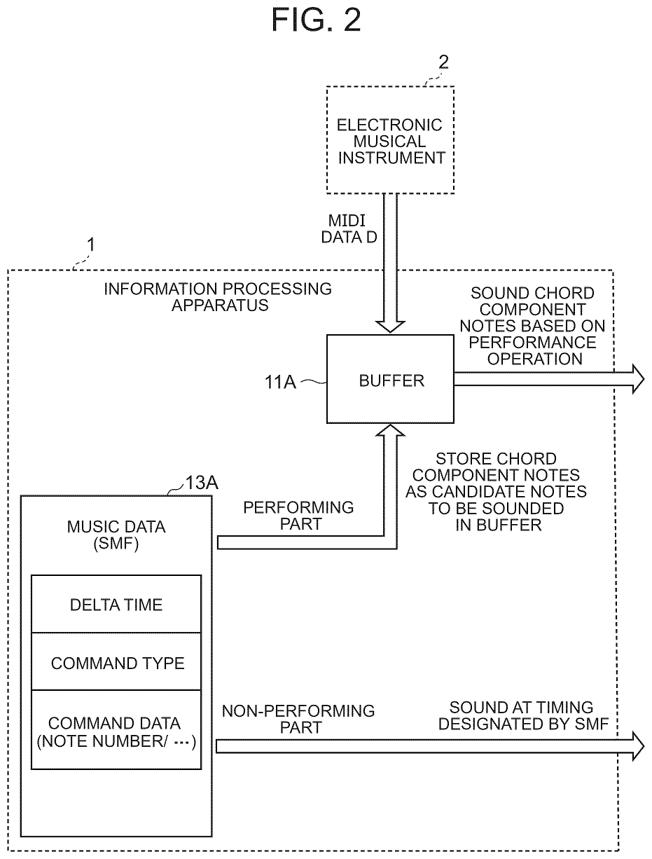

The information processing apparatus 1 is an example of a computer. As shown in FIG. 2, the information processing apparatus 1 has a hardware configuration including a processor 10, a random access memory (RAM) 11, a read only memory (ROM) 12, a flash memory 13, a display 14, a switch panel 15, a MIDI interface 16, a sound source large scale integration (LSI) 17, a D/A converter 18, and an amplifier 19. These various components of the information processing apparatus 1 are connected via a bus 20.

The processor 10 reads out programs and data stored in the ROM 12. The processor 10 uses the RAM 11 as a work area to comprehensively control the information processing apparatus 1.

For instance, the processor 10 may be a single processor or a multi-processor, and includes at least one processor. When the processor 10 includes multiple processors, it may be packaged as a single device, or may be configured as multiple devices that are physically separated within the information processing apparatus 1. For instance, the processor 10 may be called a control unit, a central processing unit (CPU), a microprocessor unit (MPU) or a micro controller unit (MCU).

The RAM 11 temporarily stores data and programs. The RAM 11 holds various programs and various data such as music data, and waveform data read from the ROM 12, for example.

As described below, a memory area of the RAM 11 is reserved as a buffer 11A. Another memory area of the RAM 11 is reserved as a buffer 11B. The buffer 11A stores the pitch name numbers of the chord component notes. The buffer 11B stores the note number of the key pressed by the user and the note number of the musical tone being sounded so that they are in association with each other. The buffer 11A may store note numbers of the chord component notes in each octave range. An octave range is the 12 semitone range from pitch names C to B (pitch name numbers 0 to 11). For instance, the octave range numbered 1 is the range of pitches C1 to B1. For instance, the octave range numbered 2 is the range of pitches C2 to B2.

It is noted that any reference to an element using a designation such as “first” and “second” in this disclosure does not generally limit the quantity or order of those elements. These designations are used for convenience to distinguish between two or more elements. Thus, reference to first and second elements does not imply, for example, that only two elements are used and that the first element precedes the second element.

The ROM 12 stores a control program 12A. The processor 10 executes the control program 12A to execute various processes according to one embodiment of the present disclosure.

The flash memory 13 stores a plurality of pieces of music data 13A. These pieces of music data 13A are data for different songs. For convenience, however, they are given the same reference number 13A. For instance, the music data 13A is created in a standard MIDI file (SMF) format. The music data 13A includes a plurality of events. The events include a delta time, a command type, and command data written therein. That is, the music data 13A includes a plurality of events (an example of information on a plurality of musical tones that constitute a song), each of which is associated with a sounding timing.

The command type is information such as note-on, note-off, control change, pitch bend change, and expression. In the MIDI standard, this is called a status byte. The command data is configuration information for the command indicated by the command type. The command data includes information such as a note number and velocity. In the MIDI standard, this is called a data byte.

The processor 10 sequentially reads the events in the music data 13A and progresses the music according to the delta time described in each event. The music data 13A is not limited to those stored in the flash memory 13. For instance, the music data 13A may be obtained via a universal serial bus (USB) memory, via the internet, or via a smartphone.

For instance, the display 14 includes a liquid crystal display (LCD) and an LCD controller. When the LCD controller drives the LCD in accordance with the control signal from the processor 10, a screen corresponding to the control signal is displayed on the LCD. The LCD may be configured as a touch panel display. The LCD may be replaced by other forms of displays, such as organic electro luminescence (EL) or light emitting diode (LED).

The switch panel 15 includes a plurality of switches and buttons for the user to perform various operations. For instance, the switch panel 15 includes a power switch, a volume knob, a button for the user to select a song, a button for the user to select a performing part to be played, a button for the user to start playing a song, and a button for the user to stop playing a song.

The MIDI interface 16 connects the information processing apparatus 1 and the electronic musical instrument 2 so that they are communicable with each other. For instance, the MIDI interface 16 receives an input that is MIDI data output by the electronic musical instrument 2.

For instance, the ROM 12 stores the waveform data. The waveform data is loaded into the RAM 11 during the startup process of the information processing apparatus 1 so that the musical notes are promptly produced according to the music data 13A. The processor 10 instructs the sound source LSI 17 to read out the corresponding waveform data from the waveform data loaded in the RAM 11.

The sound source LSI 17 produces musical tones based on the waveform data read from the RAM 11 under the control of the processor 10. The sound source LSI 17 includes a plurality of generator sections. The sound source LSI 17 is capable of simultaneously producing musical tones in number up to the number of generator sections. In this embodiment, the processor 10 and the sound source LSI 17 are configured as separate processors. In another embodiment, the processor 10 and the sound source LSI 17 may be configured as a single processor.

Digital musical-tone data generated by the sound source LSI 17 is converted into an analog signal by the D/A converter 18, and then amplified by the amplifier 19 and output from a line-out terminal, for example. For instance, a speaker is connected to the line-out terminal, and it plays the musical tones.

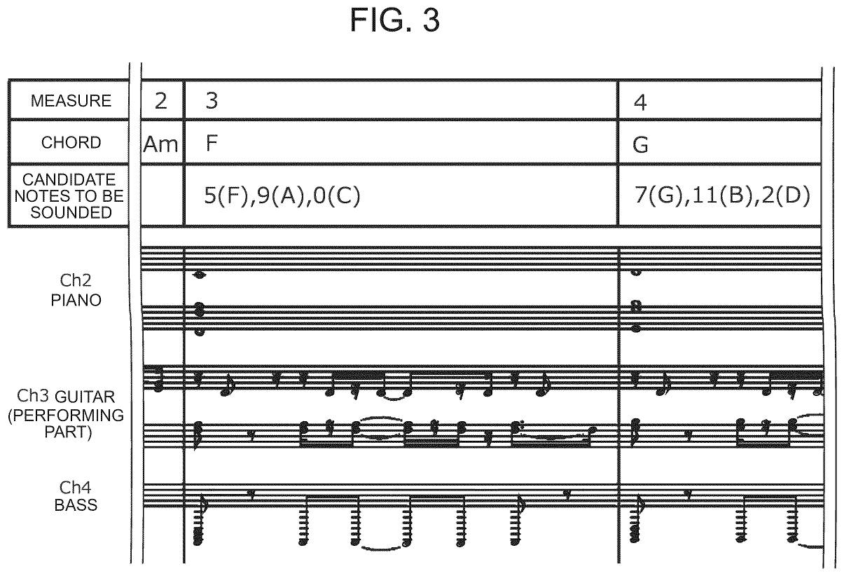

Referring to FIG. 2 and FIG. 3, the following describes an overview of the information processing apparatus, method, and program according to one embodiment of the present disclosure. An SMF (i.e., music data 13A) is made up of one or more tracks and includes multiple parts. The multiple parts include a piano part, a guitar part, a bass part, a soprano saxophone part, a drum part, and others. The user is allowed to select one performing part among these parts by operating the switch panel 15. For convenience, parts other than the performing part are described as “non-performing parts.” The music data 13A may include only one part. In this case, this one part is selected as the performing part.

The data of the performing part of the song is an example of a first part, and includes chord data. For instance, the chord data is a chord-name character string described in a meta event. The chord-name character string is text data indicating the chords such as C, CM7, and Cm7. A meta event that includes a chord-name character string is referred to as a “chord event.” The chord data of the performing part may be data of a chord part. The data of a non-performing part of the song is an example of a second part, and includes information (various events) on the multiple musical tones that make up the song.

The information processing apparatus 1 sequentially reads each event (MIDI data) included in the music data 13A. When the timing designated by the SMF for producing a musical tone of a non-performing part arrives, the information processing apparatus 1 immediately instructs the sound source LSI 17 to produce the musical tone designated by the event. That is, the information processing apparatus 1 automatically performs the musical tones of the non-performing part at the timing and velocity (volume) specified by the SMF. The velocity can be a value indicating the strength of a key depression, and also a value indicating the loudness (volume) of a musical tone.

For the performing part, the information processing apparatus 1 does not instruct the sound source LSI 17 to produce musical tones according to the SMF. The information processing apparatus 1 detects the chord component notes of the chord in progress according to the chord data, and sequentially stores, in the buffer 11A, them as candidate tones to be produced (in this embodiment, the pitch name numbers of the chord component notes are used as information on the candidate tones). The data in the buffer 11A is constantly overwritten with the latest candidate tones to be sounded as the song progresses. During a period when no chord is present (e.g., when a measure without a chord is in progress), for example, the candidate tones to be sounded in the buffer 11A are erased.

In the example of FIG. 3, the guitar part is set as the performing part. The guitar part is assigned MIDI channel 3. The information processing apparatus 1 updates the buffer 11A in accordance with the chord data transmitted and received on the MIDI channel 3.

For instance, the chords in the third and fourth measures are F and G, respectively. The chord F is composed of the chord component notes with the pitch names F, A, and C. Thus, when the music progresses to the third measure, the information processing apparatus 1 updates the pitch name numbers stored in the buffer 11A to 5, 9, and 0, which correspond to the pitch names F, A, and C. The chord G is composed of the chord component notes with the pitch names G, B, and D. Thus, when the music progresses to the fourth measure, the information processing apparatus 1 updates the pitch name numbers stored in the buffer 11A to 7, 11, and 2, which correspond to the pitch names G, B, and D.

While a user performs a musical operation with the electronic musical instrument 2, MIDI data D is input to the information processing apparatus 1. For instance, when a note-on event is input, the information processing apparatus 1 determines the chord component notes to be sounded based on the note numbers included in the note-on event and the pitch name numbers stored in the buffer 11A. The information processing apparatus 1 instructs the sound source LSI 17 to produce the determined chord component notes at the velocity included in the note-on event. That is, the information processing apparatus 1 produces the chord component notes for the performing part at the timing and volume of the user's performance operation (i.e., produces the sound of the chord component notes at the timing when the performance operation is detected with a volume according to the velocity). Although the details will be described later, the information processing apparatus 1 produces the chord component notes in the same number as the number of note-on musical tones (i.e., the number of currently pressed keys).

In this way, when the information processing apparatus 1 detects a keyboard operation (an example of an operation with a manipulation element), it processes the sounding of chord component notes in number corresponding to the current number of keys pressed (number of manipulations) based on the data of the performing part (an example of the first part). Regardless of a keyboard operation, the information processing apparatus 1 sequentially processes the sounding of multiple musical tones in accordance with various events (e.g., the production timing associated with each of the information on multiple musical tones) based on data of a non-performing part (an example of the second part).

The user is allowed to play the part they want to play at any timing and volume while letting the song automatically progress and listening to the musical tones of the non-performing part(s). Whatever a keyboard operation is performed, the performing part is produced with musically appropriate tones according to the user's performance expression (i.e., the performing part is sounded with chord component notes so that there is no discrepancy with the chord in progress).

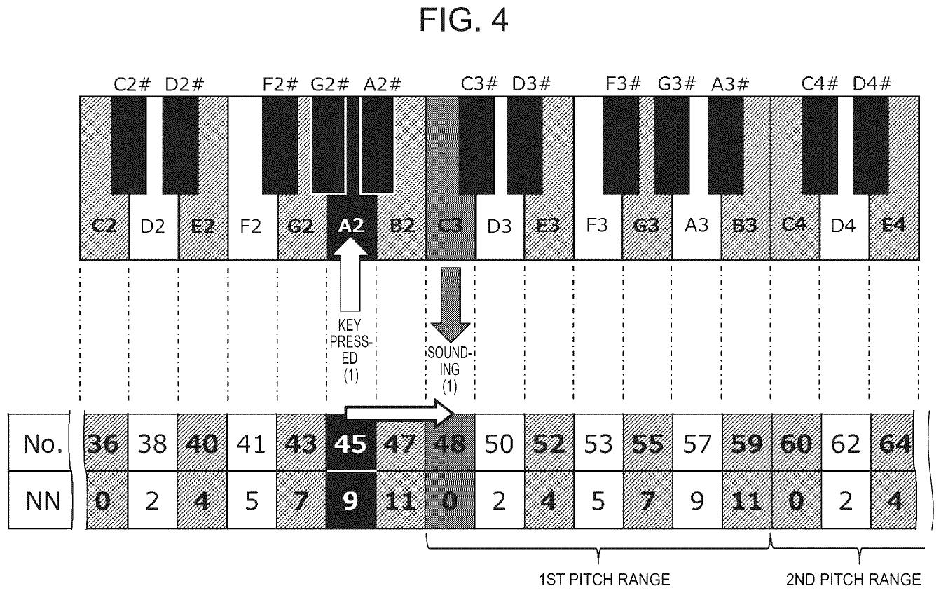

Referring to FIG. 4 to FIG. 8, the following describes how to determine the chord component notes to be sounded. For the sake of convenience, FIG. 4 to FIG. 8 show a keyboard map of only a part of the keyboard of the electronic musical instrument 2 (the key range corresponding to pitches C2 to F4). They also show a correspondence table between note numbers (No.) and pitch name numbers (NN) in this key range.

In the examples in FIG. 4 through FIG. 8, the chord in progress is CM7. CM7 is composed of the chord component notes of pitch names C, E, G, and B. In the keyboard map, the keys that correspond to the chord component notes of CM7 are hatched (for convenience, referred to as “first pattern hatching”). In the keyboard map, the keys pressed by the user (white keys in the examples of FIG. 4 to FIG. 8) are shown in black. The keys associated with pitches that are sounded when the keys are pressed are hatched in a second pattern that is different from the first pattern. The same filling rules (black filling, hatching) are applied also to the correspondence table.

The keyboard map is further marked with the words “key pressed (n)” together with an arrow indicating the key pressed by the user. The word “sounding (n)” is attached, together with an arrow indicating the key that corresponds to the pitch of the note that is sounded by the key being pressed, where n is a natural number that indicates the key pressing order (the order of keys currently pressed by the user) and the sounding order of the corresponding musical tones).

The length of each arrow on the keyboard map indicates the velocity. The shorter the arrow, the smaller the velocity at which the key is pressed, and the corresponding velocity at which the sound is produced (such as the volume of the sound) also becomes smaller. The longer the arrow, the greater the velocity at which the key is pressed, and the corresponding velocity at which the sound is produced (such as the volume of the sound) also becomes greater.

In the example of FIG. 4, the key associated with pitch A2 (note number 45) is pressed (see key pressed (1)). When the key is pressed, the root note closest to the pressed key position among the chord component notes that are the candidate notes to be sounded is first determined as the sounding target.

The “root note closest to the pressed key position” is the root note having the smallest absolute value of the difference from the note number of the pressed key (for convenience, this will be referred to as “absolute difference value V1”). As an exception, if there are multiple root notes with the same absolute difference value V1, the root note with the lowest pitch becomes “the root note closest to the pressed key position”. In the example of FIG. 4, the note number of the pressed key is 45, while the note numbers of the root notes of each octave range with the note name C (pitches C2, C3, and C4) are 36, 48, and 60, respectively. This means that their absolute difference values V1 are 9, 3, and 15, respectively. Thus, the root note of the pitch C3, which has the smallest absolute difference value V1, is determined as the note to be sounded and is sounded (see sounding (1)).

In this way, when the current number of pressed keys (number of manipulations) is one, the root note of the chord component notes is sounded. In other words, when a key is pressed, the root note of the chord in progress in the performing part is always sounded. This ensures that the performing part is musically appropriate and stable.

Of the root notes in each octave range, the root note with the pitch closest to the pitch of the keyboard operation (an example of the pitch associated with the operated manipulation element) is sounded. The user is allowed to, to some extent, determine the root note to be sounded depending on which key is pressed. That is, even if the user performs any keyboard operation, they are allowed to produce the root note that reflects their intention.

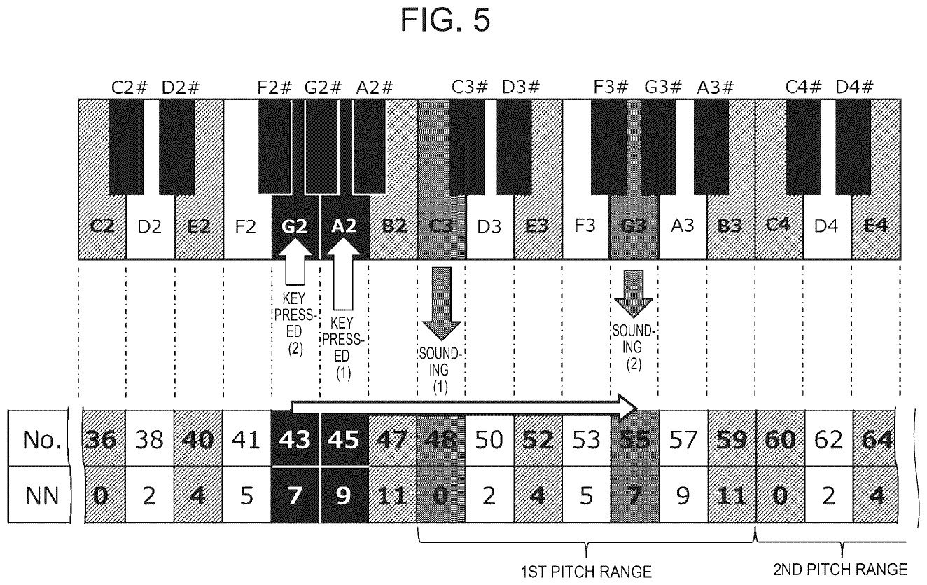

In the example in FIG. 5, the key associated with pitch G2 (note number 43) is pressed while the key associated with pitch A2 remains pressed (see key pressed (2)). In this case, the chord component note (for convenience, called the “first chord component note”) within the first pitch range (within one octave including the key corresponding to the root note) and having the smallest absolute value of the difference from the pitch name number corresponding to the key pressed (for convenience, called “absolute difference value V2”) is determined to be the target to be sounded. As an exception, if there are multiple first chord component notes with the same absolute difference value V2, the first chord component note with the lowest pitch is determined as the target to be sounded. The one-octave range C3 to B3, with the root note C3 as the lowest pitch, is an example of a first pitch range in the first octave.

The pitch C3 is the root note, meaning that the pitches E3, G3, and B3 are the first chord component notes. While the pitch name number of the key pressed is 7, the pitch name numbers corresponding to the pitches E3, G3, and B3 are 4, 7, and 11, respectively. This means that their absolute difference values V2 are 3, 0, and 4, respectively. Thus, the pitch G3, which has the smallest absolute difference value V2, is determined as the note to be sounded and is sounded (see sounding (2)).

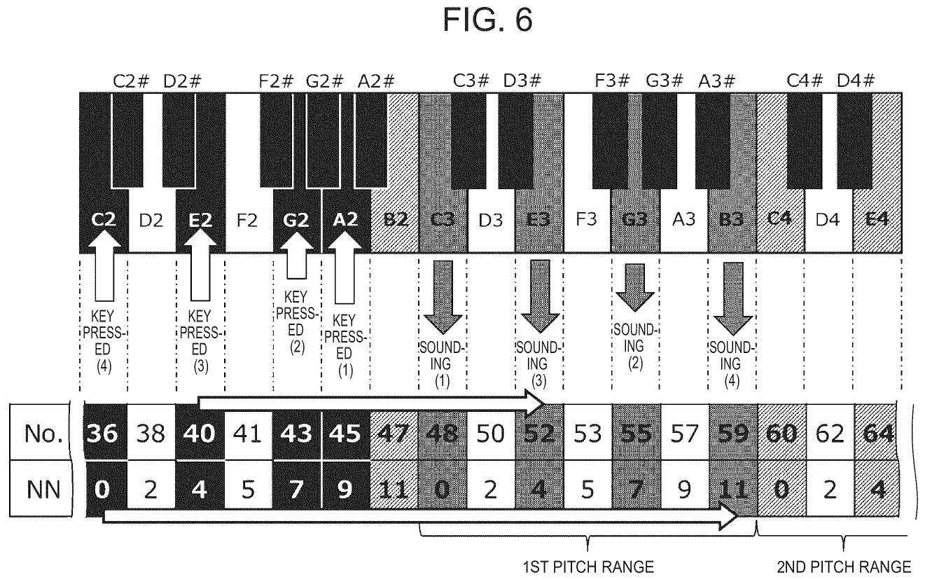

In the example in FIG. 6, the keys associated with pitch E2 (note number 40) and associated with pitch C2 (note number 36) are sequentially pressed while the two keys associated with pitches A2 and G2 remain pressed (see key pressed (3) and (4). When the key associated with pitch E2 is pressed, the first chord component note (i.e., pitch E3) with the smallest absolute difference value V2 among the unsounded first chord component notes (pitches E3, B3) is determined to be the note to be sounded and is sounded (see sounding (3)). Next, when the key associated with pitch C2 is pressed, the first chord component note (i.e., pitch B3) with the smallest absolute difference value V2 among the unsounded first chord component note (pitch B3) is determined to be the note to be sounded and is sounded (see sounding (4)).

In this way, the pitch of the chord component notes (e.g., the root note C2 or a non-root note G3) is determined based on the pitch of the keyboard operation (an example of a pitch associated with the operated manipulation element), and the chord component note of the determined pitch is sounded. The user is allowed to, to some extent, determine the chord component notes to be sounded depending on which key is pressed. That is, even if the user performs any keyboard operation, they are allowed to play the performing part with the chord component notes that reflect their intention.

If the user currently presses a plurality of keys (a plurality of number of manipulations), chord component notes with a higher pitch than the root note are sounded, in addition to the root note. In this way, the root note always is the lowest pitch musical note, which allows the performing part to be more musically appropriate and more stable.

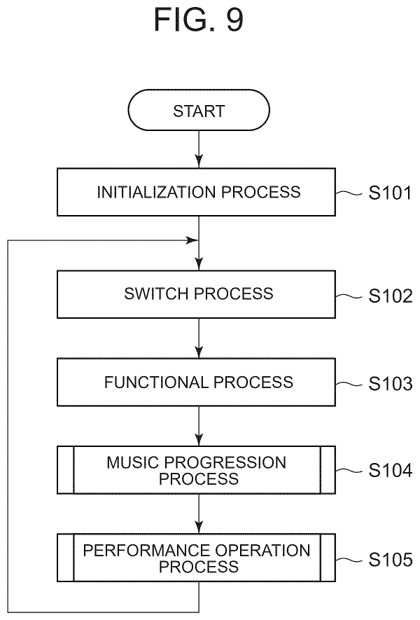

The chord component notes determined to be sounded are produced immediately. Here, when the user presses multiple keys simultaneously, the process is executed in the ascending order of note numbers of the pressed keys, for example, and the chord component notes to be sounded are determined one by one. The process of the flowchart described later (the process of steps S102 to S105 in FIG. 9, including determination of the target to be sounded and sounding instruction) is executed periodically, for example, every 1 ms. This means that a chord component note to be sounded is determined each time 1 ms elapses, and the determined chord component note is sounded sequentially each time 1 ms elapses. That is, when a user presses multiple keys simultaneously, the same number of chord component notes as the number of pressed keys are sounded substantially simultaneously.

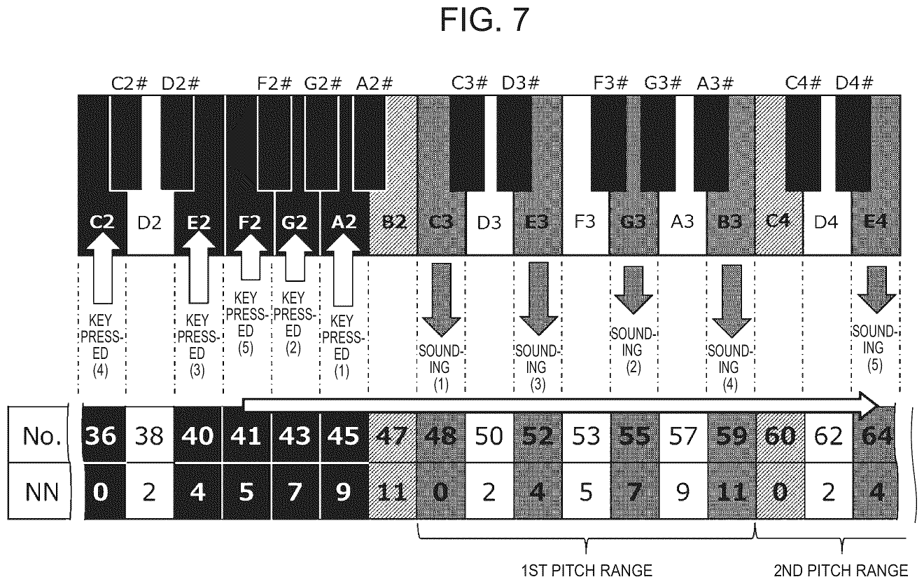

In the example in FIG. 7, the key associated with pitch F2 (note number 41) is pressed while the four keys associated with pitches A2, G2, E2, and C2 remain pressed (see key pressed (5)). In this case, all of the first chord component notes are being sounded. Thus, the chord component notes (for convenience, called the “second chord component notes”) within the second pitch range C4 to B4 of the second octave that is higher than the first pitch range C3 to B3 of the first octave (within one octave range including the key corresponding to the root note of the second octave) and having the smallest absolute difference value V2 is determined to be the target to be sounded. The one-octave range C4 to B4 is an example of a second pitch range in the second octave that is different from the first octave.

The pitches C4, E4, G4, and B4 are the second chord component notes. While the pitch name number of the key pressed is 5, the pitch name numbers corresponding to the pitches C4, E4, G4 and B4 are 0, 4, 7, and 11, respectively. This means that their absolute difference values V2 are 5, 1, 2, and 6, respectively. Thus, the pitch E4, which has the smallest absolute difference value V2, is determined as the note to be sounded and is sounded (see sounding (5)).

If the current number of keys pressed (number of manipulations) exceeds the number of notes that make up the chord, the second chord component notes (an example of chord component notes within a second pitch range of a second octave different from the first octave) and that exceed in the above-mentioned number of notes are sounded, in addition to the root note and all first chord component notes (an example of all chord component notes within a first pitch range of a first octave with the root note as the lowest pitch). This avoids a shortage in the number of notes that are sounded when the number of notes that make up a chord is set as the upper limit of the notes to be sounded, for example. For instance, when a user presses many keys using the fingers of both hands, the chord component notes in a number corresponding to the number of pressed keys are sounded, allowing for a greater variety of musical expression.

The second chord component notes may be close to the first chord component notes with a difference of a semitone or whole tone (i.e., they are within two semitones of each other). In this case, dissonance may occur. As will be described in more detail later, the second chord component note (an example of chord component notes within the second pitch range) that is within two semitones of any first chord component note within the first pitch range is not sounded. This is to avoid the occurrence of dissonance.

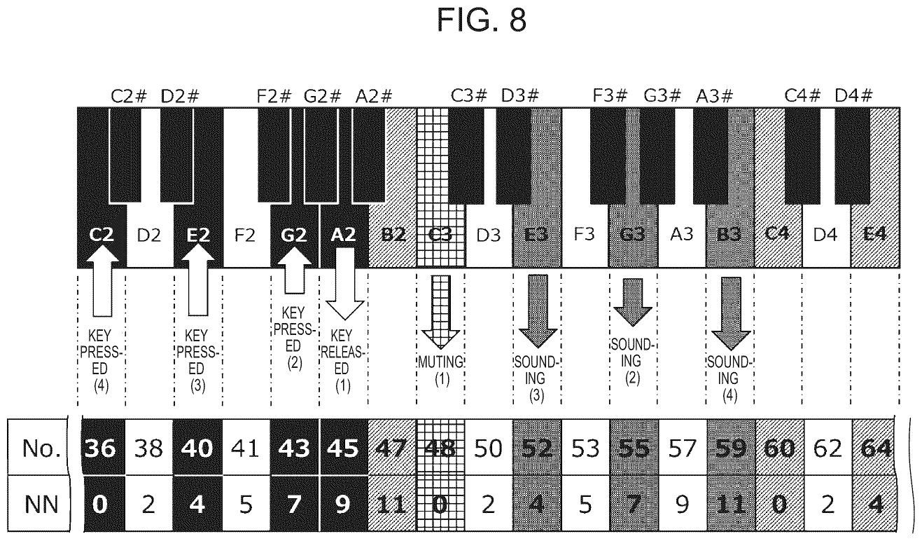

In the example in FIG. 8, the key associated with pitch A2 is released while the four keys associated with pitches A2, G2, E2, and C2 remain pressed (see key released (1)). In this case, the pitch C3 that was sounded in response to the key depression of the pitch A2 is muted (see muting (1)).

The user is allowed to play the part they want to play at any timing and volume while letting the song automatically progress and listening to the musical tones of the non-performing part(s). Whatever a keyboard operation is performed, the performing part is produced with musically appropriate tones according to the user's performance expression (i.e., the performing part is sounded with chord component notes so that there is no discrepancy with the chord in progress). Users who are not good at playing musical instruments also is able to enjoy the performance.

More specifically, the information processing apparatus 1 sounds the chord component notes corresponding to the current number of keys pressed (more specifically, the same number as the number of keys pressed). For instance, the user is able to perform single-note, two-chord, or three-chord performances at their own will, even when performing any keyboard operations, and is able to easily perform complex performance expressions.

As the chord progresses in the performing part, the information of the candidate notes to be sounded in the buffer 11A is automatically replaced. Therefore, the user is able to freely play the electronic musical instrument 2 and still play the song with the musically appropriate musical notes (chord component notes) that are to be sounded at that moment.

Referring to FIG. 9, the following describes the flowchart showing the process executed by the processor 10 in one embodiment of the present disclosure. For instance, when the information processing apparatus 1 is powered on, the execution of the process shown in FIG. 9 starts. When the information processing apparatus 1 is turned off, the execution of the process shown in FIG. 9 ends.

The order of the steps in the flowchart shown in this embodiment may be changed to the extent without contradiction. For instance, this disclosure illustrates various steps of the process using an example order, and the process is not limited to the order illustrated. The steps of the flowchart shown in this embodiment may be executed in parallel to the extent without contradiction.

As shown in FIG. 9, the processor 10 executes an initialization process (step S101). In the initialization process, various components are initialized. Variables also are initialized, including resetting of the buffers 11A and 11B.

The processor 10 executes the switch process (step S102). In the switch process, the operational states of various manipulation elements on the switch panel 15 are obtained. For instance, information such as volume information and tone information are acquired.

The processor 10 executes the functional process (step S103). In the functional process, the functions corresponding to the operational status of the various manipulation elements obtained in step S102 are executed. For instance, when a music playback start button is pressed, a music playback start process is executed. When a song selection button is pressed, the selected music data 13A is loaded from the flash memory 13 into the RAM 11.

The processor 10 executes the music progression process (step S104). In the music progression process, the song progresses as time passes.

The processor 10 executes the performance operation process (step S105). In the performance operation process, while MIDI data D corresponding to the user's performance operation is input from the electronic musical instrument 2, the process corresponding to that performance operation is executed.

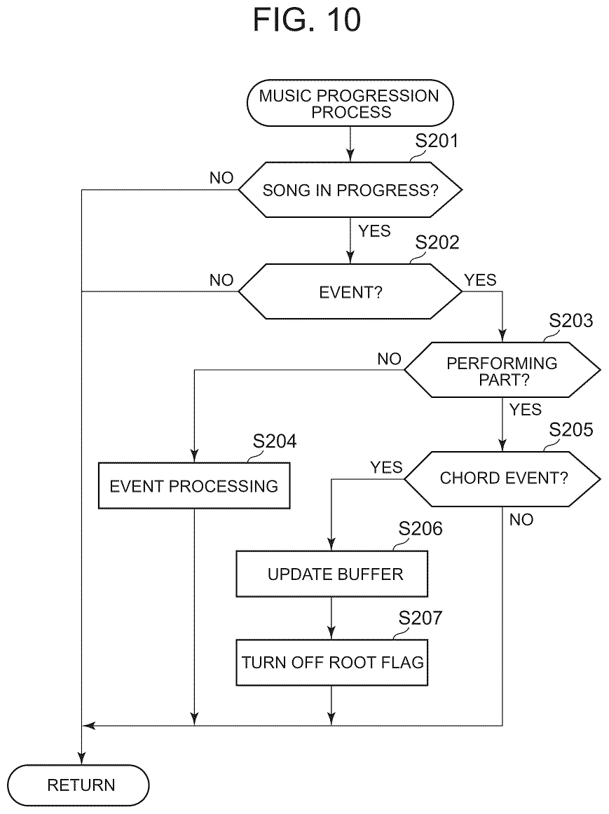

Referring to FIG. 10, the following describes a subroutine for the music progression process in step S104 in FIG. 9. As shown in FIG. 10, the processor 10 determines whether a song is in progress (step S201). A song is in progress if the user has pressed the music playback start button and has not pressed the music playback stop button or the song has not finished. If the song is not in progress (step S201: NO), the processor 10 ends the subroutine of the music progression process (step S104 in FIG. 9).

When a song is in progress (step S201: YES), the processor 10 determines whether or not there is an event to be processed in the current progress time (step S202). If there are no events to be processed (step S202: NO), the processor 10 ends the subroutine for the music progression process (step S104 in FIG. 9).

If there is an event to be processed (step S202: YES), the processor 10 determines whether this event is an event of the performing part (step S203). If it is an event of a non-performing part (step S203: NO), the processor 10 executes event processing such as generating or muting the musical tones of the non-performing part and various control changes in accordance with the description of the event (step S204), and ends the subroutine of the music progression process (step S104 in FIG. 9).

If it is an event of the performing part (step S203: YES), the processor 10 determines whether this event is a chord event (step S205).

The flash memory 13 stores a chord table. In the chord table, the pitch names (e.g., C, E, and G) of the chord component notes and pitch name numbers (e.g., 0, 4, and 7) are registered in association with the chord. In the chord table, chord component notes (e.g., C3, E3, G3, C4, and E4) in each octave range and their corresponding note numbers (e.g., 48, 52, 55, 60, and 64) may be registered in association with the chord.

If the event of the performing part is a chord event (step S205: YES), the processor 10 updates the buffer 11A (step S206). Specifically, the processor 10 determines the chord from the chord name character string described in the chord event. The processor 10 refers to the chord table and obtains the pitch name numbers of the chord component notes determined based on the chord name character string. The processor 10 stores the acquired pitch name numbers in the buffer 11A by overwriting.

That is, the processor 10 sequentially stores the pitch name numbers of the chord component notes as information on the candidate notes to be sounded in the buffer 11A in accordance with the chord data. The processor 10 may store the pitch names in the buffer 11A in addition to or instead of the pitch name numbers. The processor 10 refers to the pitch name numbers stored in the buffer 11A to calculate candidate notes to be sounded, for example.

When a chord event occurs, the chord may have changed from the previous measure, for example. Then, the processor 10 turns off the root flag (step S207). The root flag indicates whether or not the root note of the chord in progress is sounded. After the processor 10 turns off the root flag, it ends the subroutine of the music progression process (step S104 in FIG. 9).

If the event of the performing part is not a chord event (step S205: NO), the processor 10 ends the subroutine of the music progression process (step S104 in FIG. 9) without processing this event. That is, the processor 10 does not process events other than chord events for the performing part.

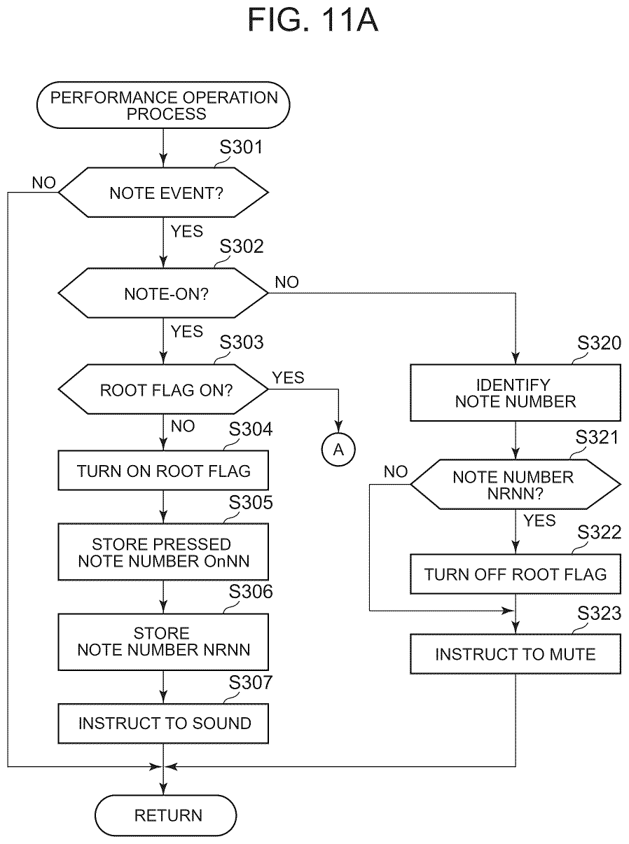

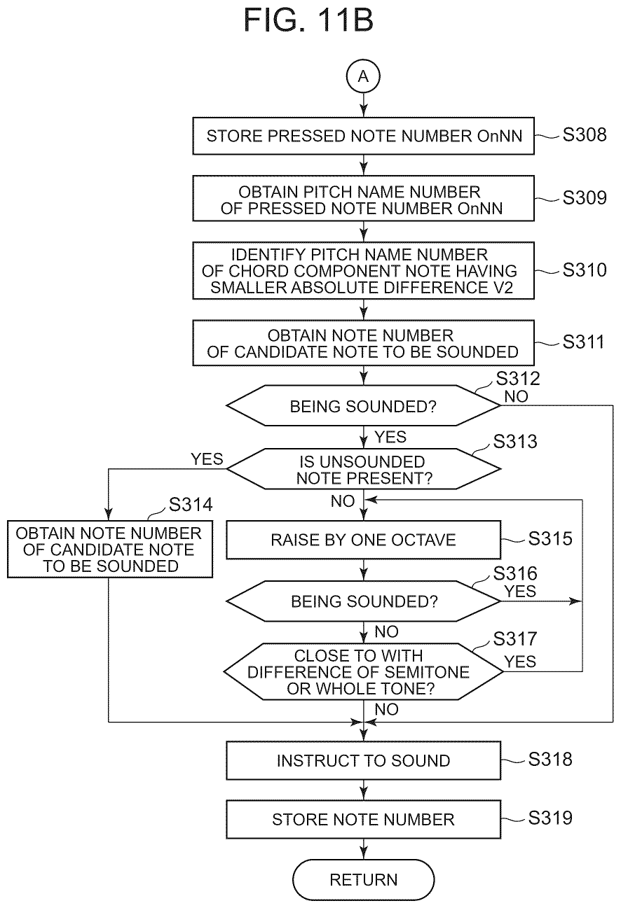

Referring to FIG. 11A and FIG. 11B, the following describes a subroutine for the performance operation process in step S105 in FIG. 9. In this performance operation process, when a key depression operation is detected, the chord component notes of the performing part are sounded based on the information on the candidate notes to be sounded stored in the buffer 11A. Note that, as mentioned above, during the period when there is no chord (e.g., during the progression of a measure with no chord), information on candidate notes to be sounded is not in the buffer 11A. In this case, an error process is performed, for example, where no chord component notes of the performing part are sounded.

In response to a user's keyboard operation on the electronic musical instrument 2, a note event is input to the information processing apparatus 1. As shown in FIG. 11A, the processor 10 determines the presence or not of a note event (step S301). If a note-on event is present (step S301: YES, step S302: YES), the processor 10 proceeds to the process of step S303. If a note-off event is present (step S301: YES, step S302: NO), the processor 10 proceeds to the process of step S320. If there is no note event (step S301: NO), the processor 10 ends the subroutine for the performance operation process (step S105 in FIG. 9).

In step S303, the processor 10 determines whether the root flag is on. In other words, the processor 10 determines whether the root note of the chord in progress is being sounded. If the root flag is off, that is, if the root note of the chord in progress has not been sounded (step S303: NO), the processor 10 executes the processes of steps S304 to S307 to process the sounding of the root note.

The processor 10 turns on the root flag (step S304). The processor 10 stores the pressed note number OnNN (On Note Number) in the RAM 11 (step S305). The pressed note number OnNN is the note number included in the note-on event, that is, the note number associated with the key pressed by the user.

The processor 10 associates the note number that is a nearest root note number (NRNN) of the root note that is closest to the pressed note number OnNN with the pressed note number OnNN and stores it in the RAM 11 (step S306). Specifically, the processor 10 determines the note number NRNN using the following expressions and stores the determined note number NRNN in the buffer 11B of the RAM 11 in association with the pressed note number OnNN.

Pitch name number a=remainder of (pressed note number OnNN/12) (1);

Octave region number b=quotient of (pressed note number OnNN/12)−1 (2);

Root-note note number c=(b+1)×12+pitch name number of the root note (3);

Root-note note number d=c−12 (4-1)

(or root-note note number d=c+12 (4-2));

Absolute difference e=|Root-note note number c−pressed note number OnNN| (5);

and

Absolute difference f=|Root-note note number d−pressed note number OnNN| (6).

That is, the processor 10 calculates the pitch name number a that corresponds to the key pressed by the user (see expression (1)). The processor 10 calculates the number b of the octave region of the key pressed by the user (see expression (2)). The processor 10 calculates the note number (one of note numbers c and d) of the root note that is closest to the pressed note number OnNN among the note numbers below OnNN, and calculates the note number (the other of note numbers c and d) of the root note that is closest to the pressed note number OnNN among the note numbers equal to or greater than OnNN (see expressions (3), (4-1) and (4-2)). Note here that, when the root-note note number c is equal to or greater than the pressed note number OnNN, the expression (4-1) applies. When the note number c of the root note is less than the pressed note number OnNN, expression (4-2) applies.

The absolute difference values e and f are an example of the above-mentioned absolute difference value V1. The processor 10 calculates the absolute difference value e between the pressed note number OnNN and the root-note note number c and the absolute difference value f between the pressed note number OnNN and the root-note note number d (see expressions (5) and (6)). When the absolute difference value e is smaller than the absolute difference value f, the processor 10 determines the note number c as the note number NRNN. When the absolute difference value f is smaller than the absolute difference value e, the processor 10 determines the note number d as the note number NRNN. When the absolute difference value e and the absolute difference value f are the same, the processor 10 determines the lower of note numbers c and d as the note number NRNN.

In the example in FIG. 4, the key corresponding to note number 45 (pitch A2) is pressed. Thus, the pitch name number 9 corresponding to the pitch name A is calculated, and 2 is calculated as the number b of the octave region. The chord in progress is CM7, meaning that the pitch name number of the root note C is 0. Thus, the root-note note numbers c and d are calculated as 36 and 48, respectively. The absolute difference values e and f are 9 and 3, respectively, meaning that note number 48 is determined as the note number NRNN.

The processor 10 instructs the sound source LSI 17 to sound the musical tone with note number NRNN (pitch C3 in the example in FIG. 4) at the velocity included in the note-on event (step S307). This allows a musically appropriate root note that matches the chord progression to be sounded, no matter what key the user presses.

In step S303, if the root flag is on, that is, if the root note is being sounded (step S303: YES), the processor 10 executes the processes of steps S308 to S319 to process the sounding of the chord component notes. First, the processor 10 stores the pressed note number OnNN in the RAM 11 (step S308).

The processor 10 obtains the pitch name number of the pressed note number OnNN (step S309). The processor 10 compares the pitch name number of each chord component note other than the root note with the pitch name number of the pressed note number OnNN. The processor 10 identifies the pitch name number of the chord component note with the smallest absolute difference value (i.e., absolute difference value V2) from the pitch name number of the pressed note number OnNN (step S310).

The processor 10 obtains the note number of the candidate note to be sounded (step S311). Specifically, the processor 10 obtains the note number of the chord component note having the pitch name number identified in step S310 among the first chord component notes (i.e., the chord component notes within the first pitch range of the first octave with the root note as the lowest pitch) as the note number of the candidate note to be sounded.

The processor 10 determines whether or not the musical tone of the note number obtained in step S311 is being sounded (step S312). If it is not being sounded (step S312: NO), the processor 10 instructs the sound source LSI 17 to produce the musical tone of the note number obtained in step S311 with the velocity included in the note-on event (step S318). The processor 10 associates the note number obtained in step S311 (i.e., the note number of the musical note that is instructed to be sounded) with the pressed note number OnNN obtained in step S309 and stores it in the buffer 11B in the RAM 11 (step S319).

If the musical tone of the note number obtained in step S311 is being sounded (step S312: YES), the processor 10 determines whether there are unsounded chord component notes among the first chord component notes (step S313). If there is an unsounded first chord component note (step S313: YES), the processor 10 acquires the note number of the first chord component note having the smallest absolute difference value V2 among the unsounded first chord component notes as the note number of the candidate note to be sounded (step S314). The processor 10 issues an instruction to produce the musical tone of the acquired note number (step S318) and stores the tone in the buffer 11B (step S319).

If there are no unsounded chord component notes among the first chord component notes within the first pitch range of the first octave (step S313: NO), the processor 10 raises the candidate notes to be sounded by one octave (step S315). Specifically, the processor 10 adds the value 12 to the note number obtained in step S311.

The processor 10 determines whether the candidate note to be sounded one octave higher obtained in step S315 is being sounded (step S316). If the candidate note to be sounded one octave higher is not being sounded (step S316: NO), the processor 10 determines whether or not there is any chord component note being sounded that is close to the chord component note within the second pitch range of the second octave one octave higher, which is obtained in step S315, with a difference of a semitone or whole tone (i.e., whether or not there is any chord component note that is within two semitones of the candidate component note one octave higher) (step S317). This is to avoid the dissonance. The processor 10 repeats the process of steps S315 to S317 until a chord component note that is not yet sounded and is close thereto with a difference of a semitone or whole tone is found.

If there is no chord component note that is close to the candidate note to be sounded one octave higher, which is obtained in step S315, with a difference of a semitone or a whole tone among the chord component notes being sounded (step S317: NO), a dissonant tone will be avoided. Thus, the processor 10 instructs to sound (step S318) and stores in the buffer 11B (step S319) the candidate note to be sounded that is one octave higher (or two or more octaves higher) and has no semitone or whole tone difference.

If a note-off event is input (step S302: NO), the processor 10 refers to the buffer 11B to identify the note number of the musical note being sounded that is stored in association with the note number included in the note-off event (step S320). The processor 10 determines whether or not the identified note number is note number NRNN (step S321). If the note number is NRNN (step S321: YES), the processor 10 turns off the root flag (step S322) and instructs the sound source LSI 17 to mute the musical tone of the note number identified in step S320 (step S323). If the note number is not NRNN (step S321: NO), the processor 10 does not turn off the root flag and instructs the sound source LSI 17 to mute the musical tone of the note number identified in step S320 (step S323).

The present disclosure is not limited to the above embodiments, and may be modified variously for implementation without departing from the scope of the invention. The functions performed in the embodiments may be combined for implementation as appropriate as possible. The embodiments include various steps, and various aspects of the invention can be extracted by combining a plurality of constituent elements in the disclosure. For example, some elements may be deleted from the constituent elements disclosed in the embodiments. Such a configuration after deletion also can be extracted as the invention as long as the configuration can have the advantageous effects as mentioned above.

The above embodiments describe a mode in which a song progresses automatically regardless of the presence or absence of a user's performance operation. The mode applicable to the information processing apparatus, method, and program according to the present embodiment is not limited to this.

In another embodiment, a mode in which a song progresses only when the user conducts a performance operation (i.e., a song does not progress unless the user conducts a performance operation) may be applied to the information processing apparatus, method and program of this embodiment. Also in this mode, the user is able to perform single-note, two-chord, or three-chord performances at their own will, even when performing any keyboard operations, and is able to easily perform complex performance expressions.

The data of performing part is not limited to the data of a chord event or a chord part, which is one of meta events, but may be data of a melody part. In the performing part, the lowest pitch musical tone is the root note in the above embodiment. However, in another embodiment, it may be a musical tone of the melody part. In yet another embodiment, the musical tones of the melody part may be the musical tone of the highest pitch, and the chord component notes including the root note may be sounded at a pitch lower than that of the musical tones of the melody part.

In the above embodiment, the sounding target is selected with priority from among the first chord component notes (i.e., the chord component notes within the first pitch range of the first octave with the root note as the lowest pitch). In another embodiment, regardless of whether or not it is the first chord component note, the chord component note of the note number closest to the pressed note number OnNN may be selected with priority. That is, chord component notes closer to the pitch associated with the key pressed by the user may be sounded with priority over the chord component notes within a one-octave range whose lowest pitch is the root note. This allows the user to produce the chord component notes in the higher pitch range or the chord component notes in the lower pitch range at their own will by operating the keyboard.

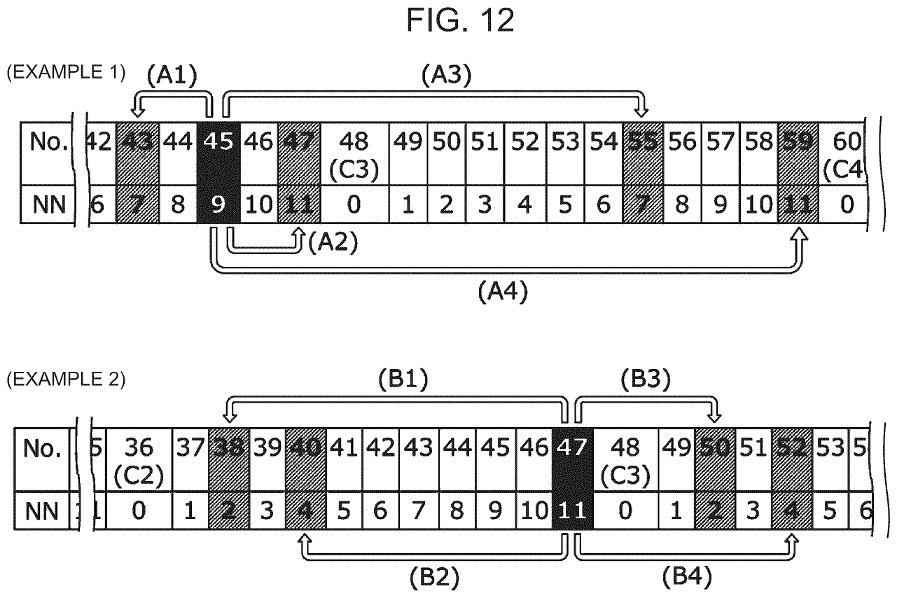

Referring to FIG. 12, the following describes two examples of how to select chord component notes in another embodiment. In Example 1, note number 45 (pitch name number 9) is the pressed note number OnNN. The pitch name G (pitch name number 7) and pitch name B (pitch name number 11) are the chord component notes. The processor 10 first starts calculations for the octave region (note numbers 36 to 47), to which the pressed note number OnNN belongs.

The processor 10 calculates the difference values of note numbers in order from the chord component note with the smallest pitch name number. Specifically, the processor 10 obtains the value 2 as the difference between the pressed note number OnNN (note number 45) and the pitch name number 7 (note number 43) (see arrow (A1)), and stores this in the RAM 11 as the minimum value. The processor 10 then obtains the value 2 as the difference between the pressed note number OnNN (note number 45) and the pitch name number 11 (note number 47) (see arrow (A2)). This value 2 is the same as above, meaning that the processor 10 does not update the minimum value.

Next, the processor 10 starts calculations for the region one octave higher (note numbers 48 to 59). Specifically, the processor 10 obtains the value 10 as the difference between the pressed note number OnNN (note number 45) and the pitch name number 7 (note number 55) (see arrow (A3)). The value is greater than the value 2, meaning that the processor 10 does not update the minimum value. The processor 10 then obtains the value 14 as the difference between the pressed note number OnNN (note number 45) and the pitch name number 11 (note number 59) (see arrow (A4)). The value is greater than the value 2, meaning that the processor 10 does not update the minimum value.

The chord component note with a lower pitch is given priority as the target for sounding. Thus, in Example 1, the chord component note of note number 43 (pitch G2) corresponding to the minimum value (value 2) is determined as the target for sounding.

In Example 2, note number 47 (pitch name number 11) is the pressed note number OnNN. The pitch name D (pitch name number 2) and pitch name E (pitch name number 4) are the chord component notes. The processor 10 first starts calculations for the octave region (note numbers 36 to 47), to which the pressed note number OnNN belongs.

Specifically, the processor 10 obtains the value 9 as the difference between the pressed note number OnNN (note number 47) and the pitch name number 2 (note number 38) (see arrow (B1)), and stores this in the RAM 11 as the minimum value. The processor 10 then obtains the value 7 as the difference between the pressed note number OnNN (note number 47) and the pitch name number 4 (note number 40) (see arrow (B2)). The value is less than the value 9, meaning that the processor 10 updates the minimum value to the value 7.

Next, the processor 10 starts calculations for the region one octave higher (note numbers 48 to 59). Specifically, the processor 10 obtains the value 3 as the difference between the pressed note number OnNN (note number 47) and the pitch name number 2 (note number 50) (see arrow (B3)). The value is less than the value 7, meaning that the processor 10 updates the minimum value to the value 3. The processor 10 then obtains the value 5 as the difference between the pressed note number OnNN (note number 47) and the pitch name number 4 (note number 52) (see arrow (B4)). The value is greater than the value 3, meaning that the processor 10 does not update the minimum value. Thus, in Example 2, the chord component note of note number 50 (pitch D3) corresponding to the minimum value (value 3) is determined as the target for sounding.

In the example of FIG. 12, the chord component notes of the octave region, to which the pressed note number OnNN belongs and the region one octave higher, are the candidate notes to be sounded. Instead of or in addition to the chord component notes of the region one octave higher, the chord component notes of the region one octave lower may also be the candidate notes to be sounded. Comparison and updating of the minimum value may be conducted stepwise for each octave region, which enables more reliable determination of the chord component notes with note numbers close to the pressed note number OnNN as the sounding target.

What is claimed is:

1. An information processing apparatus comprising:
a memory; and
at least one processor,
the at least one processor being configured to
as music progresses in accordance with music data, sequentially write or overwrite each of a plurality pieces of chord data included in the music data to the memory, the chord data being a performing data played by a user,
detect a user operation on manipulation elements by a user, and
process to sound one or more chord component notes corresponding to the piece of chord data stored in the memory at a timing of detecting the user operation, the one or more chord component notes being in number according to the number of user operations of the manipulation elements, to which the user operations are being detected.

2. The information processing apparatus according to claim 1, wherein the at least one processor is configured to
determine a pitch of each chord component note on a basis of a pitch associated with each manipulation element operated by the user, and
process to sound the chord component note at the determined pitch.

3. The information processing apparatus according to claim 1, in a case that the number of user operations is one, the at least one processor processes to sound a root note of the chord component notes.

4. The information processing apparatus according to claim 3, wherein the at least one processor is configured to process to sound a root note in an octave region, the root note being closest to a pitch associated with the operated manipulation element among root notes in octave regions.

5. The information processing apparatus according to claim 3, in a case that the number of user operations is plural, the at least one processor processes, in addition to the root note, to sound one of the chord component notes at a pitch higher than the pitch of the root note.

6. The information processing apparatus according to claim 3, in a case that the number of user operations exceeds the number of the chord component notes that make up the chord, the at least one processor processes to sound, in addition to all chord component notes within a first pitch range of a first octave, one or more chord component notes within a second pitch range of a second octave different from the first octave, wherein the number of the one or more chord component notes is the exceeded number.

7. The information processing apparatus according to claim 6, wherein the at least one processor does not process to sound one of chord component notes that is within two semitones of a difference from the chord component notes in the first pitch range and the chord component notes in the second pitch range.

8. The information processing apparatus according to claim 1, wherein the music data includes data for a first part, which is the performing part, and data for a second part, which is a non-performing part by user,
the data for the first part includes the plurality pieces of chord data of a song,
the data for the second part includes information on a plurality of musical tones that constitute the song, and
the at least one processor is configured to
in a case that user operations on the manipulation elements are detected, process to sound the chord component notes in number corresponding to the number of the user operations based on the data of the first part, and
regardless of whether or not the user operations on the manipulation elements, sequentially process to sound the plurality of musical tones in accordance with sounding timing associated with each of information on the plurality of musical tones based on data of the second part.

9. An electronic musical instrument comprising:
the information processing apparatus according to claim 1; and
at least one manipulation element.

10. A method of causing at least one processor to execute the following processing of:
as music progresses in accordance with music data, sequentially writing or overwriting each of a plurality pieces of chord data included in the music data to a memory, the chord data being a performing data played by a user,
detecting a user operation on manipulation elements by a user, and
processing to sound one or more chord component notes corresponding to the piece of chord data stored in the memory at a timing of detecting the user operation, the one or more chord component notes being in number according to the number of user operations of the manipulation elements, to which the user operations are being detected.

11. The method according to claim 10 causing the at least one processor to execute the following processing of:
determining a pitch of each chord component note on a basis of a pitch associated with each manipulation element operated by the user, and
processing to sound the chord component note at the determined pitch.

12. The method according to claim 10 causing the at least one processor to execute the following processing of: in a case that the number of user operations is one, processing to sound a root note of the chord component notes.

13. The method according to claim 12 causing the at least one processor to execute the following processing of: processing to sound a root note in an octave region, the root note being closest to a pitch associated with the operated manipulation element among root notes in octave regions.

14. The method according to claim 12 causing the at least one processor to execute the following processing of: in a case that the number of user operations is plural, processing, in addition to the root note, to sound one of the chord component notes at a pitch higher than the pitch of the root note.

15. The method according to claim 12 causing the at least one processor to execute the following processing of: in a case that the number of user operations exceeds the number of the chord component notes that make up the chord, processing to sound, in addition to all chord component notes within a first pitch range of a first octave, one or more chord component notes within a second pitch range of a second octave different from the first octave, wherein the number of the one or more chord component notes is the exceeded number.

16. The method according to claim 15 causing the at least one processor to execute the following processing of: not processing to sound one of chord component notes that is within two semitones of a difference from the chord component notes in the first pitch range and the chord component notes in the second pitch range.

17. The method according to claim 10, wherein the music data includes data for a first part, which is the performing part, and data for a second part, which is a non-performing part by user,
the data for the first part includes the plurality pieces of chord data of a song,
the data for the second part includes information on a plurality of musical tones that constitute the song, and
the method causes the at least one processor to execute the following processing of:
in a case that user operations on the manipulation elements are detected, processing to sound the chord component notes in number corresponding to the number of the user operations based on the data of the first part, and
regardless of whether or not the user operations on the manipulation elements, sequentially processing to sound the plurality of musical tones in accordance with sounding timing associated with each of information on the plurality of musical tones based on data of the second part.
